(19) United States
(12) Patent Application Publication
(10) Pub. No.: US 2026/0029538 A1
(43) Pub. Date: Jan. 29, 2026

(54) POSITIONING DEVICE

(71) Applicant: SEIKO EPSON CORPORATION, Tokyo (JP)

(72) Inventors: Satoshi USUKURA, MATSUMOTO-SHI (JP); Hiroshi UOZUMI, MATSUMOTO-SHI (JP)

(73) Assignee: SEIKO EPSON CORPORATION, Tokyo (JP)

(21) Appl. No.: 19/277,393

(22) Filed: Jul. 23, 2025

(30) Foreign Application Priority Data
Jul. 23, 2024 (JP) 2024-117858

(51) Int. Cl. G01S 19/10; H04B 1/00

(52) U.S. Cl. CPC G01S 19/10; H04B 1/0028; H04B 1/0096

(57) ABSTRACT

A positioning device including a first integrated circuit and a second integrated circuit is provided. The first integrated circuit includes a first reception unit configured to convert a first satellite signal into a first intermediate frequency signal, and a first conversion unit configured to convert the first intermediate frequency signal into a first baseband signal. The second integrated circuit includes a second reception unit configured to convert a second satellite signal into a second intermediate frequency signal, and a second conversion unit configured to convert the second intermediate frequency signal into a second baseband signal. The first integrated circuit is configured to transmit, to the second integrated circuit, a synchronization signal for synchronizing a first timing signal for controlling the first conversion unit with a second timing signal for controlling the second conversion unit of the second integrated circuit.

The present application is based on, and claims priority from JP Application Serial Number 2024-117858, filed Jul. 23, 2024, the disclosure of which is hereby incorporated by reference herein in its entirety.

### BACKGROUND

### 1. Technical Field

The present disclosure relates to a positioning device.

### 2. Related Art

WO 2019/155703 describes a satellite positioning signal reception device including a GNSS reception circuit that functions as a master and acquires navigation data in L1 and a satellite observation value, and a GNSS reception circuit that functions as a slave and acquires navigation data in L2/L5 and a satellite observation value. By resetting a PPS counter of the slave GNSS reception circuit at the rising edge of one PPS output from a PPS counter of the master GNSS reception circuit, both the PPS counters are synchronized with each other, and dual-frequency satellite observation values are acquired at the same time. The master GNSS reception circuit executes positioning calculation by using the navigation data in L1 and the satellite observation value that are acquired by the own circuit and the navigation data in L2/L5 and the satellite observation value that are transferred from the slave GNSS reception circuit.

According to the satellite positioning signal reception device described in WO 2019/155703, the timing at which the satellite processing units in both the GNSS reception circuits execute acquisition and tracking of baseband signals, decoding of navigation data, and acquisition of satellite observation values is synchronized. However, the timing of receiving satellite signals and extracting baseband signals is not synchronized.

### SUMMARY

According to an aspect of the present disclosure, a positioning device includes a first integrated circuit and a second integrated circuit. The first integrated circuit includes a first reception unit configured to receive a first satellite signal transmitted from a satellite and convert the first satellite signal into a first intermediate frequency signal, a first conversion unit configured to convert the first intermediate frequency signal into a first baseband signal, and a first baseband processing unit configured to process the first baseband signal. The second integrated circuit includes a second reception unit configured to receive a second satellite signal transmitted from the satellite and convert the second satellite signal into a second intermediate frequency signal, a second conversion unit configured to convert the second intermediate frequency signal into a second baseband signal, and a second baseband processing unit configured to process the second baseband signal. The first integrated circuit is configured to transmit, to the second integrated circuit, a synchronization signal for synchronizing a first timing signal for controlling operation timing of the first conversion unit with a second timing signal for controlling operation timing of the second conversion unit of the second integrated circuit.

### BRIEF DESCRIPTION OF THE DRAWINGS

FIG. 1 is a diagram illustrating a configuration example of a positioning device of the embodiment.

FIG. 2 is a diagram illustrating a configuration of a navigation message in the L1 band in GPS.

FIG. 3 is a diagram illustrating a configuration of a navigation message in the L5 band in GPS.

FIG. 4 is a timing chart diagram illustrating waveforms of various signals in a GNSS reception IC 10.

FIG. 5 is a timing chart diagram illustrating waveforms of various signals on the assumption that the GNSS reception IC 10 and a GNSS reception IC 20 are not synchronized with each other.

FIG. 6 is a timing chart diagram illustrating waveforms of various signals in the GNSS receptions IC 10 and 20.

FIG. 7 is a flowchart diagram illustrating an example of a procedure of processing by the GNSS reception IC 10.

FIG. 8 is a flowchart diagram illustrating an example of a procedure of processing by the GNSS reception IC 20.

### DESCRIPTION OF EMBODIMENTS

A preferred embodiment of the present disclosure is described in detail below with reference to the drawings. Note that the embodiment to be described below does not unduly limit the content of the present disclosure described in the claims. In addition, not all configurations to be described below are essential constituent elements of the present disclosure.

### 1. Embodiment

### 1-1. Configuration of Positioning Device

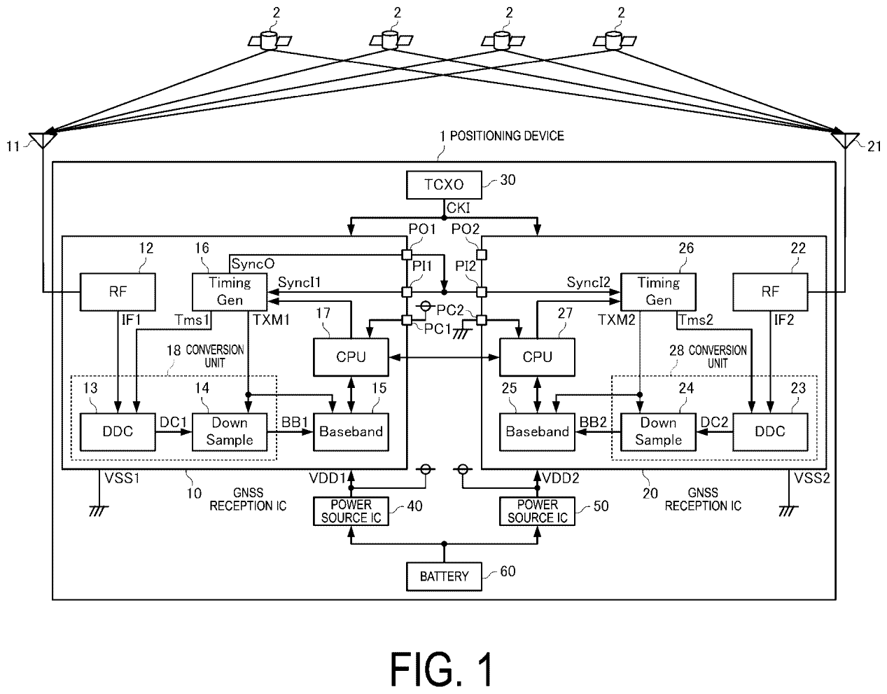

FIG. 1 is a diagram illustrating a configuration example of a positioning device 1 of the embodiment. As the details thereof are described below, the positioning device 1 receives a satellite signal transmitted from a satellite 2, and executes positioning based on the received satellite signal.

As illustrated in FIG. 1, the positioning device 1 of the embodiment includes GNSS reception ICs 10 and 20, antennas 11 and 21, a TCXO 30, power source ICs 40 and 50, and a battery 60. However, the positioning device 1 may be configured by omitting or changing some of the constituent elements in FIG. 1 or adding other constituent elements. GNSS is an abbreviation for Global Navigation Satellite System. IC is an abbreviation for Integrated Circuit. TCXO is an abbreviation for Temperature Compensated Crystal Oscillator.

The GNSS reception ICs 10 and 20 are operated by power supplied from the battery 60 via the power source ICs 40 and 50, respectively. In other words, the battery 60 is commonly shared by the GNSS reception ICs 10 and 20. The battery 60 may be a primary battery or a secondary battery. The power source IC 40 converts an output voltage of the battery 60 into a predetermined DC voltage, and outputs the DC voltage as a power source voltage VDD1 to the GNSS reception IC 10. The power source IC 50 converts an output voltage of the battery 60 into a predetermined DC voltage, and outputs the DC voltage as a power source voltage VDD2 to the GNSS reception IC 20. The GNSS reception IC 10 is operated based on the power source voltage VDD1 and the ground voltage VSS1, and the GNSS reception IC 20 is operated based on the power source voltage VDD2 and a ground voltage VSS2.

The antennas 11 and 21 are antennas that receive various radio waves including a satellite signal transmitted from each of the plurality of satellites 2, and are coupled to the GNSS reception ICs 10 and 20, respectively. The GNSS reception ICs 10 and 20 receives a satellite signal transmitted from each of the plurality of satellites 2 via the antennas 11 and 21, respectively, and executes predetermined arithmetic processing, based on the received satellite signal.

The satellite 2 is an artificial satellite that orbits the Earth on a predetermined orbit and constitutes a part of GNSS. Examples of GNSS include GPS, QZSS, EGNOS, GLONASS, GALILEO, BeiDou, and the like. GPS is an abbreviation for Global Positioning System. QZSS is an abbreviation for Quasi Zenith Satellite System. EGNOS is an abbreviation for European Geostationary Navigation Overlay Service. GLONASS is an abbreviation for Global Navigation Satellite System. In the following description, an example where the satellite system to which the satellite 2 belongs is GPS is given.

The satellite 2 transmits satellite signals to the ground by superimposing navigation messages on radio waves in a plurality of frequency bands such as the L1 band having a center frequency of 1.57542 GHz and the L2 band having a center frequency of 1.22760 GHz. In GPS, there are approximately 30 satellites 2. In order to identify the satellite 2 that transmits a satellite signal, each of the satellites 2 superimposes a code with a unique 1023-chip pattern on the satellite signal in the L1 band. The code in the L1 band is referred to as a C/A code in which each chip is +1 or −1. The code appears as a random pattern, and is repeated with a 1 ms cycle. C/A is an abbreviation for Coarse/Acquisition Code.

Further, some of the satellites 2 transmit satellite signals to the ground by superimposing navigation messages on radio waves in the L5 band having a center frequency of 1.17645 GHz. Each of the satellites 2 superimposes a code with a unique 10230-chip pattern on the satellite signal in the L5 band. Similarly to the C/A code, in the code in the L5 band, each chip is +1 or −1. The code appears as a random pattern, and is repeated with a 1 ms cycle.

In the embodiment, the GNSS reception IC 10 and the GNSS reception IC 20 receive satellite signals in different frequency bands, and execute the arithmetic processing. For example, the frequency band of the satellite signal received by the GNSS reception IC 20 may be lower than the frequency band of the satellite signal received by the GNSS reception IC 10. In the following description, it is assumed that the GNSS reception IC 10 receives the satellite signal in the L1 band and the GNSS reception IC 20 receives the satellite signal in the L5 band being a frequency band lower than the L1 band. The GNSS reception IC 10 can detect the C/A code superimposed on the satellite signal in the L1 band by correlating the satellite signal with the pattern of each C/A code. Similarly, the GNSS reception IC 20 can detect the code superimposed on the satellite signal in the L5 band by correlating the satellite signal with the pattern of each code used in the L5 band.

The satellite signal transmitted from each of the satellites 2 includes orbit information indicating a position of each of the satellites 2 in the orbit. Further, an atomic clock is installed in each of the satellites 2, and the satellite signal includes highly accurate time information measured by the atomic clock. Therefore, in the positioning device 1, the GNSS reception ICs 10 and 20 collaborate to receive satellite signals from four or more satellites 2, and positioning calculation is executed by using the orbit information and the time information included in each of the satellite signals. In this manner, the accurate information relating to the position of the antennas 11 and 21 being a reception point and the time can be acquired. Specifically, the positioning device 1 may calculate a difference between the time of each of the satellites 2 and the time at the reception point by using the orbit information included in each of the satellite signals, may calculate a pseudo-distance between each of the satellites 2 and the reception point, based on the time difference, may formulate a four-dimensional equation with four variables including a three-dimensional position (x, y, z) of the reception point and a time t by using the pseudo-distance, and may obtain a solution thereof.

Note that a slight time error of the atomic clock installed in each of the satellites 2 is measured by a control segment on the ground, the satellite signal also includes a time correction parameter for correcting the time error, and the time at the reception point is corrected by using the time correction parameter. With this, the highly accurate time information can be acquired.

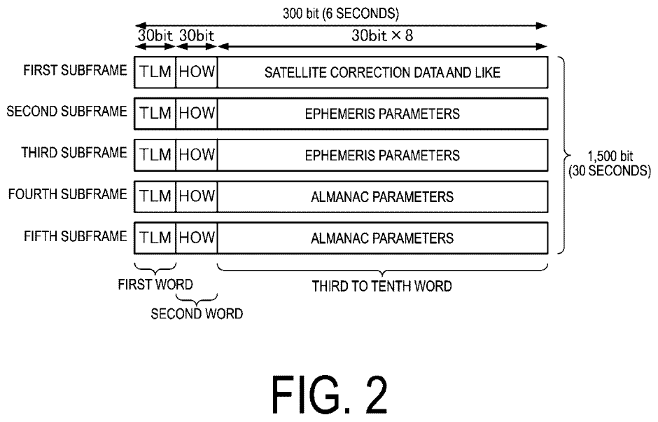

FIG. 2 is a diagram illustrating a configuration of a navigation message in the L1 band. As illustrated in FIG. 2, the navigation message in the L1 band is configured as data in which a main frame having a total of 1,500 bits serves as one unit. The main frame is divided, from the beginning, into five subframes including first to fifth subframes, and each of the subframes has 300 bits. One subframe of data is transmitted in six seconds from each satellite 2. Thus, one mainframe of data is transmitted from each satellite 2 in 30 seconds.

The 300-bit data included in each of the five subframes is divided, from the beginning, into first to tenth words, and each of the words has 30 bits. In each of the subframes, the first word is a TLM word, and the second word is a HOW word. TLM is an abbreviation for TeLeMetry, and HOW is an abbreviation for Hand Over Word. Therefore, the TLM word and the HOW word are transmitted from the satellite 2 at an interval of six seconds.

The TLM word includes preamble data, TLM message, reserved bits, and parity data.

The HOW word includes time information called TOW or Z count. TOW is an abbreviation for Time Of Week. The Z count data is displayed as the elapsed time in seconds from 00:00 on Sunday of each week, and is reset to 0 at 00:00 on the following Sunday. In other words, the Z count data is time information expressed in seconds for each week starting from the beginning of the week, and the elapsed time is represented in 1.5-second units. Herein, the Z count data indicates the time information when the first bit of the next subframe data is transmitted. For example, the Z count data in the first subframe indicates the time information when the first bit of the second subframe is transmitted. Further, the HOW word includes a 3-bit ID code indicating a subframe ID. In other words, the HOW words in the first to fifth subframes include ID codes “001”, “010”, “011”, “100”, and “101”, respectively. Based on week number data included in the first subframe and the HOW word in each of the subframes, the time of the satellite 2 can be calculated.

The third word to the tenth word in the first subframe include satellite correction data including a week number, a state of the satellite 2, a clock correction coefficient, and the like. In detail, the weak number and the state of the satellite 2 are included in the third word, and the clock correction coefficient is included in the eighth to tenth words. The third to tenth words in each of the second and third subframes includes ephemeris parameters being detailed orbit information relating to the satellite 2. The third to tenth words in each of the fourth and fifth subframes include almanac parameters being schematic orbit information relating to all the satellites 2. Therefore, the satellite correction data, the ephemeris parameters, and the almanac parameters are transmitted from the satellite 2 at an interval of 30 seconds.

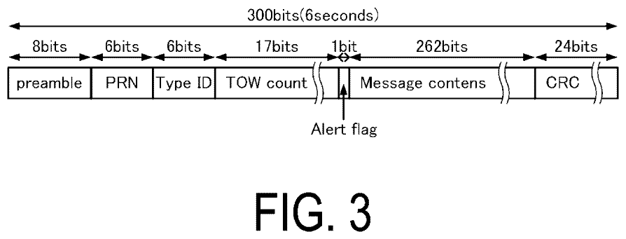

FIG. 3 is a diagram illustrating a configuration of a navigation message in the L5 band. As illustrated in FIG. 3, the navigation message in the L5 band is configured as data in which a 300-bit message serves as one unit, and is transmitted at an interval of six seconds. The 300-bit data that forms each message consists of an 8-bit preamble, a 6-bit satellite number PRN, a 6-bit message type ID, a 17-bit message TOW count, a 1-bit alert flag, a 262-bit message content, and a 24-bit CRC. CRC is an abbreviation for Cyclic Redundancy Check.

The message TOW count is a simplified 17-bit TOW count, and is expressed in a unit of 6 seconds. The actual TOW count is represented as the elapsed time from 00:00 on Sunday of each week in seconds, and is reset to 0 at 00:00 on the following Sunday. In other words, the actual TOW count is time information expressed in seconds for each week starting from the beginning of the week, and the elapsed time is represented in 1.5-second units. The message TOW count is a simplified version of the actual TOW count expressed in 17 bits.

The message content varies depending on the message type ID, and includes similar or corresponding information to that included in the navigation message in the L1 band.

Referring back to the description in FIG. 1, the GNSS reception IC 10 includes a control terminal PC1, and an input terminal PI1 and an output terminal PO1, and the GNSS reception IC 20 includes a control terminal PC2, and an input terminal PI2 and an output terminal PO2. The control terminal PC1 is a terminal for setting the GNSS reception IC 10 to a master or a slave, and the GNSS reception IC 10 is set to a master when the control terminal PC1 is at a high level, and is set to a slave when the control terminal PC1 is at a low level. The control terminal PC2 is a terminal for setting the GNSS reception IC 20 to a master or a slave, and the GNSS reception IC 20 is set to a master when the control terminal PC2 is at a high level, and is set to a slave when the control terminal PC2 is at a low level. A high-level voltage is input to one of the control terminals PC1 and PC2, and a low-level voltage is input to the other one. Therefore, one of the GNSS reception ICs 10 and 20 is set to a master, and the other one is set to a slave. In the embodiment, as illustrated in FIG. 1, the power source voltage VDD1 being a high-level voltage is input to the control terminal PC1, and the ground voltage VSS2 being a low-level voltage is input to the control terminal PC2. Therefore, the GNSS reception IC 10 is set to a master by the control terminal PC1, and the GNSS reception IC 20 is set to a slave by the control terminal PC2.

In the positioning device 1 of the embodiment, the GNSS reception IC 10 and the GNSS reception IC 20 collaborate to execute positioning. Thus, it is required to synchronize the arithmetic processing by the GNSS reception IC 10 and the arithmetic processing by the GNSS reception IC 20 with each other. The GNSS reception IC 10 being a master transmits a synchronization signal SyncO to the GNSS reception IC 20 being a slave via the output terminal PO1. In this manner, the output terminal PO1 is a terminal that outputs the synchronization signal SyncO to the outside of the GNSS reception IC 10. The GNSS reception IC 20 receives the synchronization signal SyncO as a synchronization signal SyncI2 via the input terminal PI2, and is synchronized with the synchronization signal SyncI2 to execute the arithmetic processing. In this manner, the input terminal PI2 is a terminal to which the synchronization signal SyncI2 is input from the outside of the GNSS reception IC 20. Note that the GNSS reception IC 20 is operated as a slave. Thus, there is no need to output the synchronization signal SyncO to the output terminal PO2, and the output terminal PO2 is not used.

Herein, the GNSS reception IC 10 and the GNSS reception IC 20 are mounted on a wiring substrate, which is omitted in illustration. Thus, the synchronization signal SyncO propagates through a wiring line that couples the output terminal PO1 of the GNSS reception IC 10 and the input terminal PI2 of the GNSS reception IC 20 to each other, and hence a delay occurs. Thus, a time difference occurs between the synchronization signal SyncO and the synchronization signal SyncI2. In view of this, in the embodiment, the GNSS reception IC 10 receives the synchronization signal SyncO as a synchronization signal SyncI1 via the input terminal PI1, and is synchronized with the synchronization signal SyncI1 to execute the arithmetic processing. In this manner, the input terminal PI1 is a terminal to which the synchronization signal SyncI1 is input from the outside of the GNSS reception IC 10.

The synchronization signal SyncO propagates through the wiring line that couples the output terminal PO1 and the input terminal PI1 of the GNSS reception IC 10 to each other on the wiring substrate. With this, a delay occurs, and a time difference occurs between the synchronization signal SyncO and the synchronization signal SyncI1. As a result, the time difference between the synchronization signal SyncI1 and the synchronization signal SyncI2 is reduced, and the synchronization accuracy between the arithmetic processing by the GNSS reception IC 10 and the arithmetic processing by the GNSS reception IC 20 is improved. As the time difference between the synchronization signal SyncO and the synchronization signal SyncI1 is closer to zero, the synchronization accuracy is higher. Thus, the length of the wiring line that couples the output terminal PO1 of the GNSS reception IC 10 and the input terminal PI2 of the GNSS reception IC 20 to each other may be equal to the length of the wiring line that couples the output terminal PO1 of the GNSS reception IC 10 and the input terminal PI1 of the GNSS reception IC 20 to each other.

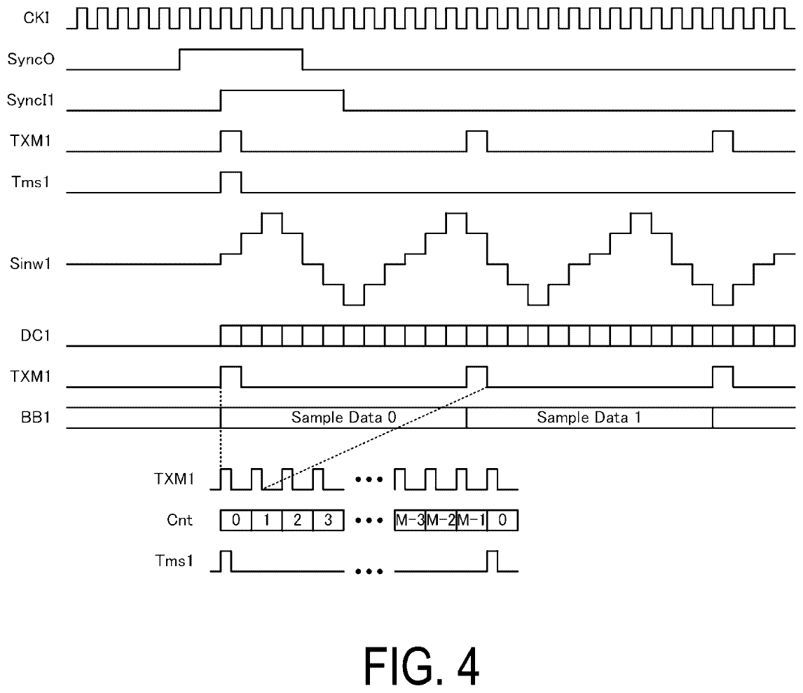

As illustrated in FIG. 1, the GNSS reception IC 10 includes an RF processing unit 12, a DDC 13, a down-sampling unit 14, a baseband processing unit 15, a timing signal generation unit 16, and a CPU 17, and is operated based on a clock signal CKI that is output from the TCXO 30. RF is an abbreviation for Radio Frequency. DDC is an abbreviation for Digital Down Converter. CPU is an abbreviation for Central Processing Unit. The frequency of the clock signal CKI is, for example, several tens MHz. FIG. 4 is a timing chart diagram illustrating waveforms of various signals in the GNSS reception IC 10. The functions and operations of the respective units are described below as appropriate with reference to FIG. 4.

The CPU 17 determines whether the GNSS reception IC 10 is operated as a master or a slave, based on a logic level of a signal that is input from the control terminal PC1. In the embodiment, the high-level voltage is input from the control terminal PC1, and hence the CPU 17 operates the GNSS reception IC 10 as a master. Specifically, the CPU 17 controls the timing signal generation unit 16 to output the synchronization signal SyncO. Further, the CPU 17 is operated as a master during communication with the CPU 27 of the GNSS reception IC 20.

Under control of the CPU 17, the timing signal generation unit 16 outputs the synchronization signal SyncO. As illustrated in FIG. 4, the synchronization signal SyncO is a signal that is at a high level for a constant period, is output from the output terminal PO1 to the outside, and is input as the synchronization signal SyncI1 from the input terminal PI1. As illustrated in FIG. 4, the synchronization signal SyncI1 is a delayed version of the synchronization signal SyncO.

The timing signal generation unit 16 is synchronized with the synchronization signal SyncI1 to generate timing signals TXM1 and Tms1. As illustrated in FIG. 4, The timing signal TXM1 is a signal that is at a high level for a constant period at a predetermined cycle. Further, the timing signal Tms1 is a signal that defines 1 ms timing and is at a high level for a constant period every 1 ms. The timing signal generation unit 16 sets the timing signal Tms1 to a high level for a constant period each time the rising edge of the timing signal TXM1 is counted M times by an internal counter, which is omitted in illustration. The timing signal TXM1 is input to the down-sampling unit 14 and the baseband processing unit 15, and the timing signal Tms1 is input to the DDC 13.

The RF processing unit 12 receives the satellite signal in the L1 band that is transmitted from each of the satellites 2, and converts the received satellite signal into an intermediate frequency signal IF1. Specifically, the RF processing unit 12 extracts the satellite signal in the L1 band from the signal received by the antenna 11 by using a bandpass filter, amplifies the extracted satellite signal by an LNA, mixes the amplified signal and a clock signal obtained by multiplying the clock signal CKI by a PLL, and down-converts the mixed signal to a signal in an intermediate frequency band of several MHz, for example. LNA is an abbreviation for Low Noise Amplifier. PLL is an abbreviation for Phase Locked Loop. Then, the RF processing unit 12 subjects the signal in the intermediate frequency band to amplification and low-pass filtering processing, and then converts the resultant signal into a digital signal by an ADC. For example, the ADC subjects the signal in the intermediate frequency band to A/D conversion in a cycle of the clock signal CKI, and outputs a digital signal. The digital signal is input as the intermediate frequency signal IF1 to the DDC 13.

The DDC 13 is synchronized with the timing signal Tms1 to convert the intermediate frequency signal IF1 into a digital signal DC1 with a center frequency of 0 Hz. Specifically, as illustrated in FIG. 4, the DDC 13 is synchronized with the timing signal Tms1 to start generation of a digital signal Sinw1 of a sine wave with a frequency of several MHz, for example. The sampling rate of the digital signal Sinw1 of a sine wave is the same as the center frequency of the intermediate frequency signal IF1. The DDC 13 mixes the intermediate frequency signal IF1 with the digital signal Sinw1 of a sine wave, and then executes low-pass filtering processing to convert the mixed wave into the digital signal DC1 with a center frequency of 0 Hz. The sampling rate of the digital signal DC1 matches with the frequency of the clock signal CKI.

As illustrated in FIG. 4, the down-sampling unit 14 subjects the digital signal DC1 to down-sampling by the timing signal TXM1, and outputs a baseband signal BB1. The baseband signal BB1 is input to the baseband processing unit 15.

In this manner, the DDC 13 and the down-sampling unit 14 function as a conversion unit 18 that converts the intermediate frequency signal IF1 into the baseband signal BB1. Therefore, the timing signals Tms1 and TXM1 is a signal that controls operation timing of the conversion unit 18.

The baseband processing unit 15 is synchronized with the timing signal TXM1 to process the baseband signal BB1. Specifically, the baseband processing unit 15 generates a local code having the same pattern as each C/A code, and executes satellite search processing which correlates the local code with each C/A code contained in the baseband signal BB1. The satellite 2 moves at high speed. Thus, due to the Doppler effect, the frequency of the satellite signal in the L1 band that is received by the GNSS reception IC 10 fluctuates within a range of approximately ±2 kHz with respect to 1.57542 GHz. The fluctuation frequency, which is known as the Doppler frequency, results in a frequency offset in the satellite signal. Thus, the baseband processing unit 15 executes the satellite search processing while also taking into account the frequency offset of the satellite signal. Specifically, the baseband processing unit 15 adjusts a phase and a chip rate of the local code so that the correlation value with respect to each local code reaches a peak. When the correlation value is a threshold or more, it is determined that the local code is synchronized with the C/A code of the satellite 2, in other words, the satellite 2 is captured.

Note that GPS adopts a CDMA method where all the satellites 2 use different C/A codes and transmit satellite signals at the same frequency. Therefore, the baseband processing unit 15 can search for the satellite 2 that can be captured by identifying the C/A code included in the received satellite signal. CDMA is an abbreviation for Code Division Multiple Access.

When the satellite 2 is captured based on the baseband signal BB1, the baseband processing unit 15 calculates the frequency offset of the satellite signal, based on the chip rate, calculates the code phase, based on the phase of the local code, and generates satellite capture information including the frequency offset of the satellite signal and the code phase. In the embodiment, the baseband processing unit 15 does not execute positioning computation, and the GNSS reception IC 20 executes positioning computation by using the satellite capture information generated by the baseband processing unit 15. Thus, the GNSS reception IC 10 transmits the satellite capture information generated by the baseband processing unit 15 to the GNSS reception IC 20. Specifically, the CPU 17 of the GNSS reception IC 10 acquires the satellite capture information generated by the baseband processing unit 15, and transmits the acquired satellite capture information to the CPU 27 of the GNSS reception IC 20.

As illustrated in FIG. 1, the GNSS reception IC 20 includes a configuration similar to that of the GNSS reception IC 10, includes an RF processing unit 22, a DDC 23, a down-sampling unit 24, a baseband processing unit 25, a timing signal generation unit 26, and a CPU 27, and is operated based on the clock signal CKI that is output from the TCXO 30. The names of the various signals in the GNSS reception IC 20 are different but similar to the names of the various signals in the GNSS reception IC 10. The timing chart illustrating the waveforms of the various signals in the GNSS reception IC 20 is similar to that in FIG. 4, and hence illustration thereof is omitted.

The CPU 27 determines whether the GNSS reception IC 20 is operated as a master or a slave, based on a logic level of a signal that is input from the control terminal PC2. In the embodiment, the low-level voltage is input from the control terminal PC2, and the CPU 27 operates the GNSS reception IC 20 as a slave. Specifically, the CPU 17 controls the timing signal generation unit 26 to receive the synchronization signal SyncO as the synchronization signal SyncI2. Further, the CPU 27 is operated as a slave during communication with the CPU 17 of the GNSS reception IC 10.

The synchronization signal SyncO that is output from the timing signal generation unit 16 of the GNSS reception IC 10 is input as the synchronization signal SyncI2 from the input terminal PI2 of the GNSS reception IC 20. The synchronization signal SyncI2 is a delayer version of the synchronization signal SyncO, and is a signal that is at a high level for a constant period at substantially the same timing with the synchronization signal SyncI1 illustrated in FIG. 4.

The timing signal generation unit 26 is synchronized with the synchronization signal SyncI2 to generate timing signals TXM2 and Tms2. The timing signal TXM2 is a signal that is at a high level for a constant period at a predetermined cycle. Further, the timing signal Tms2 is a signal that defines 1 ms timing and is at a high level for a constant period every 1 ms. The timing signal generation unit 26 sets the timing signal Tms2 to a high level for a constant period each time the rising edge of the timing signal TXM2 is counted N times by an internal counter, which is omitted in illustration. The timing signal TXM2 is input to the down-sampling unit 24 and the baseband processing unit 25, and the timing signal Tms2 is input to the DDC 23.

The RF processing unit 22 receives the satellite signal in the L5 band that is transmitted from each of the satellites 2, and converts the received satellite signal into an intermediate frequency signal IF2. Specifically, the RF processing unit 22 extracts the satellite signal in the L5 band from the signal received by the antenna 21 by using a bandpass filter, amplifies the extracted satellite signal by an LNA, mixes the amplified signal and a clock signal obtained by multiplying the clock signal CKI by a PLL, and down-converts the mixed signal to a signal in an intermediate frequency band several tens MHz, for example. Then, the RF processing unit 22 subjects the signal in the intermediate frequency band to amplification and low-pass filter processing, and then converts the resultant signal into a digital signal by an ADC. For example, the ADC subjects the signal in the intermediate frequency band to A/D conversion in a cycle of the clock signal CKI, and outputs a digital signal. The digital signal is input as the intermediate frequency signal IF2 to the DDC 23.

The DDC 23 is synchronized with the timing signal Tms2 to convert the intermediate frequency signal IF2 into a digital signal DC2 with a center frequency of 0 Hz. Specifically, the DDC 23 is synchronized with the timing signal Tms2 to start generation of a digital signal Sinw2 of a sine wave with a frequency of several tens MHz, for example. The sampling rate of the digital signal Sinw2 of a sine wave is the same as the center frequency of the intermediate frequency signal IF2. The DDC 23 mixes the intermediate frequency signal IF2 with the digital signal Sinw2 of a sine wave, and then executes low-pass filtering processing to convert the mixed wave into the digital signal DC2 with a center frequency of 0 Hz. The sampling rate of the digital signal DC2 matches with the frequency of the clock signal CKI.

The down-sampling unit 24 subjects the digital signal DC2 to down-sampling by the timing signal TXM2, and outputs a baseband signal BB2. The baseband signal BB2 is input to the baseband processing unit 25.

In this manner, the DDC 23 and the down-sampling unit 24 function as a conversion unit 28 that converts the intermediate frequency signal IF2 into the baseband signal BB2. Therefore, the timing signals Tms2 and TXM2 is a signal that controls operation timing of the conversion unit 28.

The baseband processing unit 25 is synchronized with the timing signal TXM2 to process the baseband signal BB2. Specifically, the baseband processing unit 25 generates a local code having the same pattern as each code in the L5 band, and executes satellite search processing which correlates the local code with each code contained in the baseband signal BB2. The satellite 2 moves at high speed. Thus, due to the Doppler effect, the frequency of the satellite signal in the L5 band that is received by the GNSS reception IC 20 fluctuates within a range of approximately ±2 kHz with respect to 1.17645 GHz. The fluctuation frequency, which is known as the Doppler frequency, results in a frequency offset in the satellite signal. Thus, the baseband processing unit 25 executes the satellite search processing while also taking into account the frequency offset of the satellite signal. Specifically, the baseband processing unit 25 adjusts a phase and a chip rate of the local code so that the correlation value with respect to each local code reaches a peak. When the correlation value is a threshold or more, it is determined that the local code is synchronized with the L5-band code of the satellite 2, in other words, the satellite 2 is captured.

When the satellite 2 is captured based on the baseband signal BB2, the baseband processing unit 25 calculates the frequency offset of the satellite signal, based on the chip rate, calculates the code phase, based on the phase of the local code, and generates satellite capture information including the frequency offset of the satellite signal and the code phase. Further, in the embodiment, the CPU 27 acquires satellite capture information generated by the baseband processing unit 15 of the GNSS reception IC 10, and outputs the acquired satellite capture information to the baseband processing unit 25. Further, when four or more satellites 2 can be captured, the baseband processing unit 25 demodulates the navigation message superimposed on the satellite signal transmitted from each of the satellites 2, based on the satellite capture information generated by the own unit and the satellite capture information generated by the baseband processing unit 15, and executes positioning computation. Specifically, the baseband processing unit 25 mixes the local code, which has the same pattern as the L5-band code of each of the captured satellites 2, with the baseband signal BB2 at an appropriate timing based on the frequency offset and the code phase that are included in the satellite signal included each piece of the satellite capture information, and demodulates the navigation message the orbit information and the time information that relate to each of the satellites 2. Further, the baseband processing unit 25 executes positioning by a publicly known method using the orbit information and the time information relating to the four or more satellites 2. The CPU 17 of the GNSS reception IC 10 may acquire information relating to a positioning result of the baseband processing unit 25 via the CPU 27 of the GNSS reception IC 20.

In this manner, in the embodiment, the GNSS reception IC 10 executes the arithmetic processing for the satellite signal in the L1 band, and the GNSS reception IC 20 executes the arithmetic processing for the satellite signal in the L5 band. The chip rate of the code in the L5 band is ten times that of the chip rate of the code in the L1 band. Thus, the satellite capture accuracy of the baseband processing unit 25 is higher than that of the baseband processing unit 15, but the arithmetic load of the satellite capture by the baseband processing unit 25 is higher than that by the baseband processing unit 15. Thus, the GNSS reception IC 20 receives the satellite capture information generated by the baseband processing unit 15 of the GNSS reception IC 10, and the baseband processing unit 25 demodulates the navigation message included in the baseband signal BB2, based on the received satellite capture information, and executes positioning based on the demodulated navigation message. Therefore, the baseband processing unit 25 is only required to execute minimum necessary satellite capture. Thus, the arithmetic load for satellite capture can be reduced. As a result, the power consumption of the positioning device 1 is reduced, and the battery life of the battery 60 is extended.

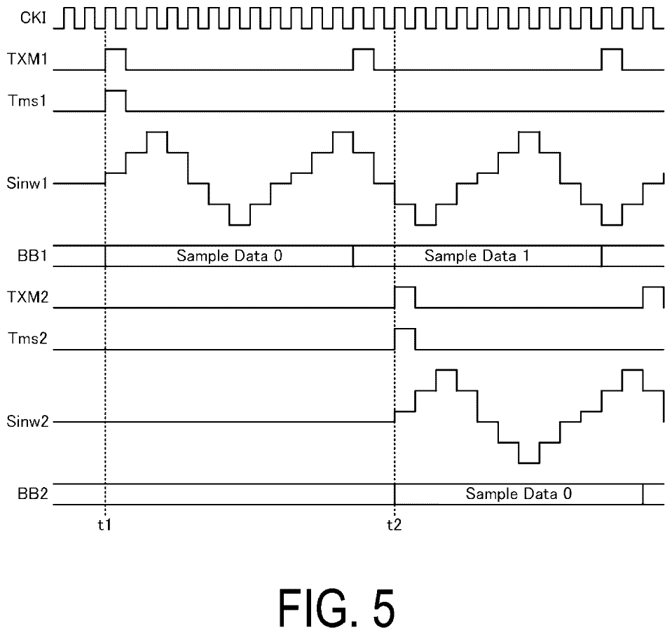

However, for example, when, hypothetically, the GNSS reception ICs 10 and 20 start the arithmetic processing at arbitrary timing, respectively, a time t1 at which the timing signal Tms1 rises and a time t2 at which the timing signal Tms2 rises do not match with each other as illustrated in FIG. 5. Consequently, data update timing of the baseband signal BB1 and data update timing of the baseband signal BB2 do not match with each other. Thus, the baseband processing unit 25 cannot accurately demodulate the navigation message superimposed on the baseband signal BB2, by using the satellite capture information that is generated by the baseband processing unit 15, based on the baseband signal BB1. In other words, it is required to synchronize the arithmetic processing of the GNSS reception IC 10 and the arithmetic processing of the GNSS reception IC 20 with each other so that the baseband processing unit 25 can accurately demodulate the navigation message, based on the satellite capture information generated by the baseband processing unit 15.

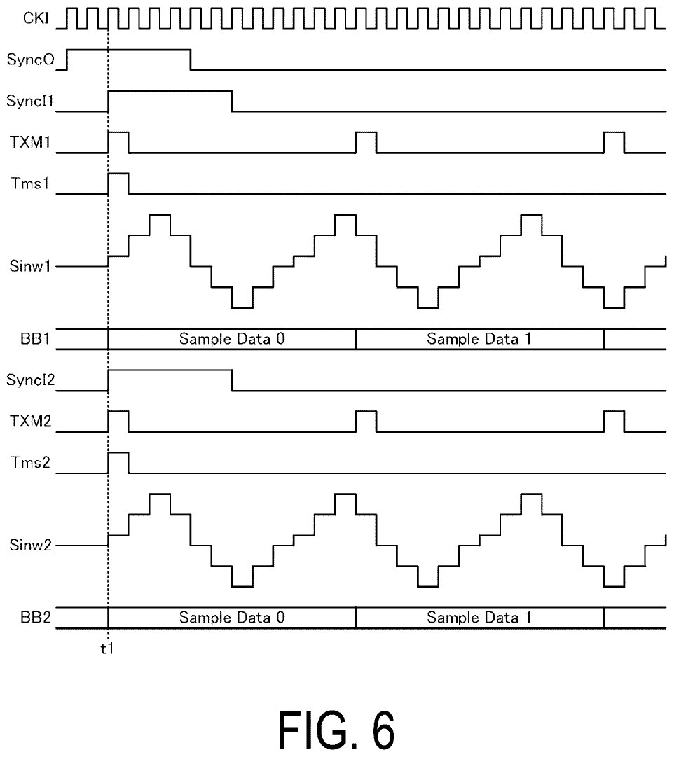

Thus, in the embodiment, as illustrated in FIG. 6, the GNSS reception IC 10 outputs the synchronization signal SyncO, and the GNSS reception ICs 10 and 20 start the arithmetic processing, based on the synchronization signals SyncI1 and SyncI2 that are respectively obtained by delaying the synchronization signal SyncO. With this, the timing signals Tms1 and Tms2 rise at the same time t1. Thus, the data update timing of the baseband signal BB1 and the data update timing of the baseband signal BB2 match with each other. Thus, the baseband processing unit 25 can accurately demodulate the navigation message superimposed on the baseband signal BB2, by using the satellite capture information that is generated by the baseband processing unit 15, based on the baseband signal BB1.

As illustrated in FIG. 1, the GNSS reception IC 10 and the GNSS reception IC 20 are integrated circuit with the same configuration in which a frequency band of a satellite signal to be received may be freely selected. The GNSS reception IC 10 may be set to receive the satellite signal in the L1 band, and the GNSS reception IC 20 may be set to receive the satellite signal in the L5 band. In this manner, when the GNSS reception ICs 10 and 20 are integrated circuit with the same configuration, the number of steps of developing the GNSS reception ICs 10 and 20 is reduced. However, the GNSS reception IC 10 and the GNSS reception IC 20 may not be integrated circuit with the same configuration. The GNSS reception IC 10 may be a configuration dedicated to reception of the satellite signal in the L1 band, and the GNSS reception IC 20 may be a configuration dedicated to reception of the satellite signal in the L5 band. In this manner, when the GNSS reception ICs 10 and 20 are integrated circuits with configurations dedicated to reception of respective satellite signals in predetermined frequency bands, the size of each of the integrated circuits can be reduced.

Note that the GNSS reception IC 10 is an example of an “first integrated circuit”, and the GNSS reception IC 20 is an example of an “second integrated circuit”. The RF processing unit 12 is an example of a “first reception unit”, and the RF processing unit 22 is an example of a “second reception unit”. The conversion unit 18 is an example of a “first conversion unit”, and the conversion unit 28 is an example of a “second conversion unit”. The baseband processing unit 15 is an example of a “first baseband processing unit”, and the baseband processing unit 25 is an example of a “second baseband processing unit”. The output terminal PO1 is an example of a “first output terminal”, the input terminal PI1 is an example of a “first input terminal”, and the input terminal PI2 is an example of a “second input terminal”. The control terminal PC1 is an example of a “first control terminal”, and the control terminal PC2 is an example of a “second control terminal”. The satellite signal in the L1 band that is received by the GNSS reception IC 10 is an example of a “first satellite signal”, and the satellite signal in the L5 band that is received by the GNSS reception IC 20 is an example of a “second satellite signal”. The intermediate frequency signal IF1 is an example of a “first intermediate frequency signal”, and the intermediate frequency signal IF2 is an example of a “second intermediate frequency signal”. The baseband signal BB1 is an example of a “first baseband signal”, and the baseband signal BB2 is an example of a “second baseband signal”. The timing signal Tms1 is an example of a “first timing signal”, and the timing signal Tms2 is an example of a “second timing signal”. The timing signal TXM1 is another example of the “first timing signal”, and the timing signal TXM2 is another example of the “second timing signal”.

### 1-2. Processing Procedure of Positioning Device

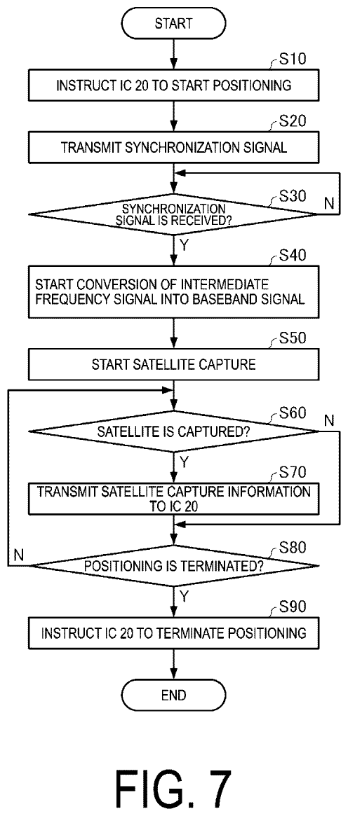

FIG. 7 is a flowchart diagram illustrating an example of a procedure of processing executed by the GNSS reception IC 10. As illustrated in FIG. 7, first, in step S10, the CPU 17 of the GNSS reception IC 10 instructs the GNSS reception IC 20 to start positioning. Subsequently, in step S20, the timing signal generation unit 16 of the GNSS reception IC 10 transmits the synchronization signal SyncO.

Subsequently, when the timing signal generation unit 16 receives the synchronization signal SyncI1 in step S30, the conversion unit 18 of the GNSS reception IC 10 is synchronized with the timing signals Tms1 and TXM1 based on the synchronization signal SyncI1 and starts conversion of the intermediate frequency signal IF1, which is output from the RF processing unit 12, into the baseband signal BB1 in step S40. Further, in step 50, the baseband processing unit 15 of the GNSS reception IC 10 is synchronized with the timing signal TXM1 to start capturing the satellite 2.

Further, until positioning by the positioning device 1 is terminated in step 80, the CPU 17 of the GNSS reception IC 10 transmits the satellite capture information that is generated by the baseband processing unit 15 to the CPU 27 of the GNSS reception IC 20 in step S70 every time the baseband processing unit 15 captures the satellite 2 in step S60.

Finally, when positioning by the positioning device 1 is to be terminated in step S80, the CPU 17 instructs the CPU 27 of the GNSS reception IC 20 to terminate positioning in step S90, and thus the processing of the GNSS reception IC 10 is terminated.

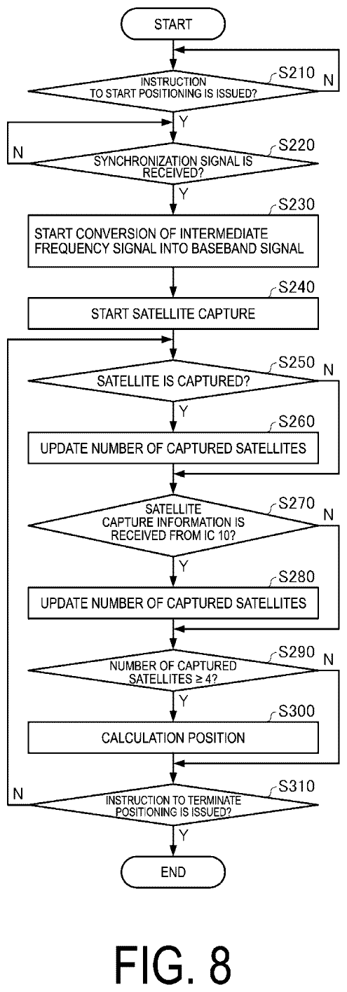

FIG. 8 is a flowchart diagram illustrating an example of a procedure of processing executed by the GNSS reception IC 20 in the embodiment. As illustrated in FIG. 8, first, in step S210, the CPU 27 of the GNSS reception IC 20 stands by until the CPU 17 of the GNSS reception IC 10 issues an instruction to start positioning. When the instruction to start positioning is issued, the timing signal generation unit 26 of the GNSS reception IC 20 stands by until the synchronization signal SyncI2 is received in step S220.

Further, when the timing signal generation unit 26 receives the synchronization signal SyncI2 in step 220, the conversion unit 28 of the GNSS reception IC 20 is synchronized with the timing signals Tms2 and TXM2 based on the synchronization signal SyncI2, and starts conversion of the intermediate frequency signal IF2, which is output from the RF processing unit 22, into the baseband signal BB2 in step S230. Further, in step 240, the baseband processing unit 25 of the GNSS reception IC 20 is synchronized with the timing signal TXM2 to start capturing the satellite 2.

Further, until the CPU 27 receives an instruction to terminate positioning from the CPU 17 in step 310, the baseband processing unit 25 updates the number of captured satellites 2 in step S260 every time the satellite 2 is captured in step S250. Further, every time the CPU 27 receives the satellite capture information from the CPU 17 of the GNSS reception IC 10 in step 270, the baseband processing unit 25 updates the number of captured satellites 2 in step S280. Further, when the number of captured satellites 2 is four or more in step S290, the baseband processing unit 25 calculates the position of the positioning device 1, based on the satellite capture information relating to the four or more captured satellites 2, in step S300.

Finally, when the CPU 27 receives the instruction to terminate positioning from the CPU 17, the processing of the GNSS reception IC 20 is terminated in step S310.

### 1-3. Actions and Effects

As described above, according to the positioning device 1 of the embodiment, due to the synchronization signal SyncO that is output from the GNSS reception IC 10, the timing at which the GNSS reception IC 10 receives the satellite signal in the L1 band to extract the baseband signal BB1 and the timing at which the GNSS reception IC 20 receives the satellite signal in the L5 band to extract the baseband signal BB2 can be synchronized with each other. Specifically, due to the synchronization signals SyncI1 and SyncI2 that are obtained by delaying the synchronization signal SyncO, the timing at which the conversion unit 18 converts the intermediate frequency signal IF1, which is output from the RF processing unit 12 into the baseband signal BB1 and the timing at which the conversion unit 28 converts the intermediate frequency signal IF2, which is output from the RF processing unit 22, into the baseband signal BB2 can match with each other. Therefore, according to the positioning device 1 of the embodiment, the GNSS reception IC 10 and the GNSS reception IC 20 can collaborate to search for each of the satellites 2 efficiently. Thus, power saving and time reduction during the search are achieved.

Further, according to the positioning device 1 of the embodiment, the length of the wiring line that couples the output terminal PO1 of the GNSS reception IC 10 and the input terminal PI2 of the GNSS reception IC 10 to each other and the length of the wiring line that couples the output terminal PO1 and the input terminal PI1 of the GNSS reception IC 10 to each other are equal to each other. Thus, the time from timing at which the synchronization signal SyncO is output from the output terminal PO1 to the timing at which the synchronization signal SyncO is input to the input terminals PI1 and PI12 can be aligned. Consequently, the operation timing of the conversion unit 18 and the operation timing of the conversion unit 28 can be synchronized with each other more accurately.

Further, according to the positioning device 1 of the embodiment, the GNSS reception IC 10 that receives the satellite signal in the L1 band serves as a master, and the GNSS reception IC 20 that receives the satellite signal in the L5 band serves as a slave. With this, the satellite 2 can be captured efficiently by receiving the satellite signals in the different frequency bands, and the GNSS reception IC 20 can execute positioning for a short period of time by utilizing the satellite capture information generated by the GNSS reception IC 10.

### 2. Modification Example

The present disclosure is not limited to the present embodiment, and various modifications can be made within the scope of the present disclosure.

For example, in the above-mentioned embodiment, the description is made while assuming that the GNSS reception IC 10 executes the arithmetic processing with respect to the satellite signal in the L1 band, and the GNSS reception IC 20 executes the arithmetic processing with respect to the satellite signal in the L5 band. The frequency bands of the satellite signals subjected to the arithmetic processing of the GNSS reception ICs 10 and 20 are not limited thereto. For example, the GNSS reception IC 10 may execute the arithmetic processing with respect to the satellite signal in the L1 band, and the GNSS reception IC 20 may execute the arithmetic processing with respect to a signal strength of the wireless communication. Alternatively, the GNSS reception ICs 10 and 20 may execute the arithmetic processing with respect to satellite signals in the same frequency band.

Further, in the above-mentioned embodiment, the GNSS reception IC 20 executes positioning computation. However, the GNSS reception IC 10 may execute positioning computation. In such a case, the GNSS reception IC 10 may receive the satellite capture information generated by the baseband processing unit 25 of the GNSS reception IC 20, and the baseband processing unit 15 may demodulate the navigation message included in the baseband signal BB1, based on the received satellite capture information, and execute positioning based on the demodulated navigation message.

Further, in the above-mentioned embodiments, the GNSS reception IC 10 is a master, and the GNSS reception IC 20 is a slave. Alternatively, the GNSS reception IC 20 may be a master, and the GNSS reception IC 10 may be a slave. In other words, the control terminal PC1 of the GNSS reception IC 10 may be at a low level, and the control terminal PC2 of the GNSS reception IC 20 may be at a high level. In such a case, the GNSS reception IC 20 outputs the synchronization signal SyncO from the output terminal PO2, and the synchronization signal SyncO is input to the input terminal PI1 of the GNSS reception IC 10 and the input terminal PI2 of the GNSS reception IC 20. Further, in the communication between the CPU 17 of the GNSS reception IC 10 and the CPU 27 of the GNSS reception IC 20, the CPU 27 is operated as a master, and the CPU 17 is operated as a slave.

The above-described embodiments and modification example are merely examples and are not intended to be limiting. For example, the embodiments and modification example may be combined as appropriate.

The present disclosure includes configurations that are substantially the same as the configurations described in the embodiments, for example, configurations with the same functions, methods and results, or with the same advantages and effects. In addition, the present disclosure includes configurations obtained by replacing non-essential portions of the configurations described in the embodiments. In addition, the present disclosure also includes configurations that achieve the same effects as the configurations described in the embodiments or configurations that can achieve the same purposes. Further, the present disclosure includes configurations obtained by adding known techniques to the configurations described in the embodiments.

The following contents are derived from the embodiments and the modification example described above.

According to an aspect, a positioning device includes a first integrated circuit and a second integrated circuit, wherein the first integrated circuit includes a first reception unit configured to receive a first satellite signal transmitted from a satellite and convert the first satellite signal into a first intermediate frequency signal, a first conversion unit configured to convert the first intermediate frequency signal into a first baseband signal, and a first baseband processing unit configured to process the first baseband signal, the second integrated circuit includes a second reception unit configured to receive a second satellite signal transmitted from the satellite and convert the second satellite signal into a second intermediate frequency signal, a second conversion unit configured to convert the second intermediate frequency signal into a second baseband signal, and a second baseband processing unit configured to process the second baseband signal, and the first integrated circuit transmits, to the second integrated circuit, a synchronization signal for synchronizing a first timing signal for controlling operation timing of the first conversion unit with a second timing signal for controlling operation timing of the second conversion unit of the second integrated circuit.

According to the positioning device, due to the synchronization signal, the timing at which the first integrated circuit receives the first satellite signal to extract the first baseband signal and the timing at which the second integrated circuit receives the second satellite signal to extract the second baseband signal can be synchronized. Therefore, according to the positioning device, the first integrated circuit and the second integrated circuit can collaborate to search for the satellite efficiently. Thus, power saving and time reduction during the search are achieved.

In an aspect of the positioning device, the first integrated circuit may include a first output terminal configured to output the synchronization signal to an outside and a first input terminal into which the synchronization signal is input from the outside, the second integrated circuit may include a second input terminal into which the synchronization signal is input from the outside, and a length of a wiring line coupling the first output terminal and the second input terminal to each other may be equal to a length of a wiring line coupling the first output terminal and the second input terminal to each other.

According to the positioning device, the time from the output of the synchronization signal from the first integrated circuit to the input to the first integrated circuit and the second integrated circuit can be equalized. Thus, the operation timing of the first conversion unit and the operation timing of the second conversion unit can be synchronized with each other more accurately.

In an aspect of the positioning device, the first integrated circuit may include a first control terminal for executing setting of a master or a slave, and may be set as a master by the first control terminal, and the second integrated circuit may include a second control terminal for executing setting of a master or a slave, and may be set as a slave by the second control terminal.

According to the positioning device, the first integrated circuit serves as a master, and the second integrated circuit serves as a slave. Thus, the first integrated circuit and the second integrated circuit can collaborate to execute positioning.

In an aspect of the positioning device, a frequency band of the second satellite signal may be lower than a frequency band of the first satellite signal.

According to the positioning device, the first integrated circuit and the second integrated circuit receive the satellite signals in the different frequency bands, and hence the satellite can be captured efficiently.

In an aspect of the positioning device, the first baseband processing unit may generate satellite capture information including a frequency offset and a code phase of the first satellite signal, based on the first baseband signal, and the first integrated circuit may transmit the satellite capture information to the second integrated circuit.

According to the positioning device, the first integrated circuit and the second integrated circuit can share the satellite capture information generated by the first integrated circuit.

In an aspect of the positioning device, the second integrated circuit may receive the satellite capture information, and the second baseband processing unit may demodulate a navigation message included in the second baseband signal, based on the satellite capture information, and execute positioning based on the navigation message.

According to the positioning device, the second integrated circuit can execute positioning for a short period of time by utilizing the satellite capture information generated by the first integrated circuit.

What is claimed is:

1. A positioning device comprising:
a first integrated circuit; and
a second integrated circuit, wherein
the first integrated circuit includes:
a first reception unit configured to receive a first satellite signal transmitted from a satellite and convert the first satellite signal into a first intermediate frequency signal;
a first conversion unit configured to convert the first intermediate frequency signal into a first baseband signal; and
a first baseband processing unit configured to process the first baseband signal,
the second integrated circuit includes:
a second reception unit configured to receive a second satellite signal transmitted from the satellite and convert the second satellite signal into a second intermediate frequency signal;
a second conversion unit configured to convert the second intermediate frequency signal into a second baseband signal; and
a second baseband processing unit configured to process the second baseband signal, and
the first integrated circuit is configured to transmit, to the second integrated circuit, a synchronization signal for synchronizing a first timing signal for controlling operation timing of the first conversion unit with a second timing signal for controlling operation timing of the second conversion unit of the second integrated circuit.

2. The positioning device according to claim 1, wherein
the first integrated circuit includes a first output terminal configured to output the synchronization signal to an outside and a first input terminal into which the synchronization signal is input from the outside,
the second integrated circuit includes a second input terminal into which the synchronization signal is input from the outside, and
a length of a wiring line coupling the first output terminal and the second input terminal to each other is equal to a length of a wiring line coupling the first output terminal and the second input terminal to each other.

3. The positioning device according to claim 1, wherein
the first integrated circuit includes a first control terminal for executing setting of a master or a slave, and is set as a master by the first control terminal, and
the second integrated circuit includes a second control terminal for executing setting of a master or a slave, and is set as a slave by the second control terminal.

4. The positioning device according to claim 1, wherein
a frequency band of the second satellite signal is lower than a frequency band of the first satellite signal.

5. The positioning device according to claim 1, wherein
the first baseband processing unit generates satellite capture information including a frequency offset and a code phase of the first satellite signal, based on the first baseband signal, and
the first integrated circuit transmits the satellite capture information to the second integrated circuit.

6. The positioning device according to claim 5, wherein
the second integrated circuit receives the satellite capture information, and
the second baseband processing unit demodulates a navigation message included in the second baseband signal, based on the satellite capture information, and executes positioning based on the navigation message.
